(19) United States
(12) Patent Application Publication
(10) Pub. No.: US 2023/0011773 A1
(43) Pub. Date: Jan. 12, 2023

(54) Optimized electric vehicle battery charging

(71) Applicants: Arunachala M. Kannan, Gilbert, AZ (US); Ashwin Chandwani, Tempe, AZ (US); Ayan Mallik, Chandler, AZ (US)

(72) Inventors: Arunachala M. Kannan, Gilbert, AZ (US); Ashwin Chandwani, Tempe, AZ (US); Ayan Mallik, Chandler, AZ (US)

(21) Appl. No.: 17/803,437

(22) Filed: Jul. 8, 2022

Related U.S. Application Data
(60) Provisional application No. 63/259,365, filed on Jul. 9, 2021.
(60) Provisional application No. 63/259,366, filed on Jul. 9, 2021.

(51) Int. Cl. B60L 53/64; G06Q 50/06; B60L 53/66

(52) U.S. Cl. CPC B60L 53/64; G06Q 50/06; B60L 53/665

(57) ABSTRACT

An onboard battery charging system including battery system and battery controller protection mechanisms and providing battery charge optimization where the protection portions of the system use an input isolation mechanism to isolate the vehicle power input from the battery controller upon detection of deviant charge voltages and a battery isolation mechanism to isolate the battery controller from the batteries upon detection of cyberattacks resulting in deviant charge power being provided to the batteries and where the charge optimization portions of the system use the same input isolation mechanisms as are employed for the vehicle system protection input isolation to regulate the timing of vehicle charging as a function of electricity prices.

### FIELD OF THE INVENTION

The present invention relates to an improved system and method for efficiently and safely managing the charging of electric vehicles using on-vehicle capabilities. More particularly the invention relates to providing optimized use of off-peak charging of electric vehicles using an already-existing set of on-board vehicle components that are also employed for mitigation of risks to vehicle systems arising from deviant charging conditions, including deviant conditions caused by cyber threats.

### BACKGROUND

With the adoption of motor vehicles that rely on electricity for some or all of their propulsion it has become necessary to provide electrical supply capabilities that are suitable for these electric vehicles. Initially hybrid electric vehicles were designed for utilization of typical household electrical outlets at either 110 or 220 volts. As a greater number of fully electric vehicles have become available there has been a growing need for faster vehicle chargers. A network of vehicle charge stations has been developed and this network continues to expand to meet this need. However, with the adoption of these charge stations, here has been some experience with undesirable interference with vehicle charging. Some of the interference has been the result of inconsistent performance of the charging stations and some of the interference has been the result of intentional disruption of performance of the charging stations.

When the electrical grid is being overwhelmed by consumer demand for electricity, it has become well known that power outages or brownouts can occur. These interruptions in grid power negatively impact the power supplied by vehicle charging stations and can interfere with vehicle charging. Another, and particularly troubling, type of charge station interference is intentional interference. Aside from disabling the charge station, there is growing concern about interference with systems onboard the vehicle. This type of interference includes cyber-attacks.

A thorough and comprehensive description of the nature of cyberattack risks for electric vehicles is provided in an article published by the inventor [Received Nov. 18, 2020, accepted Dec. 12, 2020, date of publication Dec. 16, 2020, date of current version Dec. 31, 2020. Digital Object Identifier 10.1109/ACCESS.2020.3045367 Cybersecurity of Onboard Charging Systems for Electric Vehicles—Review, Challenges and Countermeasures ASHWIN CHANDWANI, (Student Member, IEEE), SAIKAT DEY, (Student Member, IEEE), AND AYAN MALLIK, (Member, IEEE) Power Electronics and Control Engineering (PEACE) Laboratory, Arizona State University, Tempe, Ariz. 85281, USA Ira A. Fulton School of Engineering, Arizona State University, Tempe, Ariz. 85281, USA Corresponding author: Ayan Mallik] the full content of which is hereby incorporated by reference.

In addition to grid-based vehicle charging (plug-in charging) there have been additional vehicle charging arrangements proposed. These include, for instance, solar photovoltaic and thermoelectric power generation components of the energy generation kit. Solar charging of batteries has often included portable units that produce relatively low charge capabilities intended for battery charge retention rather than actual charging, but some systems have been proven capable of producing significant battery charging capabilities. Providing significant solar generation capacity onboard an electric vehicle is an efficient arrangement for keeping batteries charged and for assisting in replenishing the charge on a battery that has been drawn down.

### SUMMARY

It is known that utility companies experience periods of relatively high and relatively low demand for electricity during the course of a typical day. It is also known that changes in weather conditions from day to day can cause changes in electricity demand from one day to the next. As a result of these variations in electricity demand electric utility companies have devised a scheme through which they can provide incentives for consumers to use electricity during periods when ample electrical generation capacity is available and can discourage electricity consumption during periods of peak demand, when the grid may experience excess demand relative to generating capacity. This has led utility companies to provide peak pricing and off peak pricing in their electricity price schedules. It is possible that this peak and off peak pricing scheme could eventually be implemented to change rates on a real time basis as a result of real time energy consumption levels such that during periods of high energy consumption prices will be set according to peak schedules and during periods of relatively lower energy consumption prices will be set at the off peak rates. It is even possible that there could be a sliding scale of prices, set as a function of the extent to which grid capacity is being utilized.

There is a trend in motor vehicles to transition away from internal combustion engines in favor of electric vehicles. As this trend progresses it is anticipated that electric vehicles will comprise a material component of overall demand for electricity from the grid for recharging batteries in these electric vehicles. As a result of this material increase in overall electricity demand resulting from increased usage of electric vehicles there will be more frequent incidences of shortfalls in electric grid capacity. As a result of these more frequent shortfalls, it will be increasingly important to provide incentives for electric vehicle owners to recharge their vehicles when there are no constraints on available grid power.

In the interest of offering drivers of electric vehicles an opportunity to be socially responsible (and to save money) it is desirable to assist these drivers in optimizing their use of electricity during off peak periods and to reduce their reliance on grid power during periods of peak demand. To provide this assistance to drivers it is proposed to provide an onboard system for electric vehicles that will automatically cause vehicle charging to increase the relative portion of energy drawn from the electric grid during off peak periods and to decrease the relative portion of electricity drawn from the grid during peak periods. This can be accomplished by providing pricing information to the on-board charging system and providing a charging control system that causes vehicle charging to be regulated as a function of the price of electricity. The pricing information may be determined based on a predetermined schedule of charges that is stored in the vehicle or it could be provided in real time through an active pricing information system.

Similarly, periodic pricing updates may be provided to the system for determination whether peak or off-peak pricing is (or will be) available at any given time.

Further, a smart charging system according to the invention can anticipate the overall charge energy that will be necessary for recharging the vehicle and can determine, based on anticipated availability of onboard charge energy whether to draw energy from the grid for vehicle recharging. This determination can be Implemented as a function of additional factors such as available on-board charging capacity and anticipated external conditions, for instance the predicted sunshine (for solar charging evaluation) and predicted high or low temperatures (for prediction of energy needs in heating and/or air conditioning the vehicle). Taking a comprehensive look at charging opportunities, either from the grid or from on-board systems, allows increased efficiency in managing the cost of recharging the vehicle. Further, taking a comprehensive look at the energy demands anticipated might allow for shifting of a greater portion of the charging from grid-based charging to on-board system charging. This could be done by delaying the use of grid power when an on-board system will be able to sufficiently charge the batteries for anticipated needs, even if the amount of time needed for this recharge might be longer. Providing a user input indicative of the next planned use of the vehicle will allow an informed determination as to whether grid power is necessary for sufficiently charging of the vehicle in time for the users next planned trip.

### BRIEF DESCRIPTION OF THE DRAWINGS

FIG. 1 is an illustration of a preferred embodiment of the invention.

### DESCRIPTION OF THE INVENTION

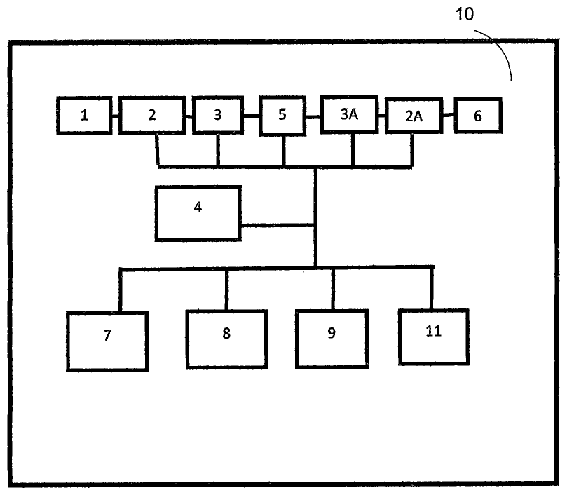

Referring to FIG. 1, there is shown a vehicle 10 having an input 1 connected to electrical grid power. This input could be connected to any type of electrical outlet such as a conventional household electrical outlet (110 or 220 volts), a dedicated vehicle charge station at any available voltage or a less common electrical outlet such as a 440 volt 3-phase outlet. The operative need is for electrical power to be available at the outlet and at a voltage and in a configuration consistent with the vehicle's charging system.

Sensor system 2 is connected to power input 1. The input voltage and current are sensed for comparison by logic system 4 to the acceptable range of input voltage and current for the electrical outlet to which the input is connected. This acceptable range of input voltage and current is determined based on the parameters specified for the power outlet, whether it is a dedicated vehicle charge station or a conventional electrical outlet. In any case, grid power (directly from the grid or via a power station) being supplied will be sensed by sensor system 2. Switch 3 will normally provide a connection from the input to the battery system to facilitate battery charging. In a preferred embodiment, the input power is directed to the battery controller 5 for regulation of the voltage provided to the batteries 6 as a function of the battery's state of charge. If the supplied voltage or current deviates from an acceptable level, then switch 2 is opened to isolate the vehicle from the power source and thus to protect the vehicle from a potentially damaging power draw. Excessive power (overvoltage) is the primary concern in relation to vehicle charging, although low voltage may lead to a failure to properly operate the charging system. The cause of incorrect voltage from the power outlet could be variations in voltage resulting from incorrect wiring or perhaps from grid overload, such as a brownout caused by system overload. It might also be the result of some form of interference with the supplied voltage, intentional or otherwise. In any event, the vehicle will be protected from overvoltage whenever the input voltage is excessive relative to the supply specifications, and it will be safeguarded in case of deficient voltage such as during a brownout.

Once the vehicle is protected from deviations in the voltage being supplied from the off-board power source (the grid) through the operation of sensor 2 and switch 3 as controlled pursuant to logic unit 4, it can be seen that it doesn't matter whether the source of the input power deviation is intentional or accidental. The vehicle is protected from potentially damaging input power levels. This protects the battery control circuitry 5 as well as the battery system 6. Once the vehicle is protected, it is possible that the voltage deviation may be resolved and in this case it is desirable to restore operation of the system. Thus, the sensor continues to monitor the input voltage when isolation is active and restores the connection after the input voltage returns to within the acceptable range of voltages. The determination how long after can be made based on a period of time (for instance 15 seconds) or perhaps after a predetermined number of successive sensor readings (for instance 50 consecutive readings) the primary concern being to restore operation of the system only after there is confidence that system operation will not be impaired by the previously present deviant voltage.

However, there is additional need for vehicle protection. As mentioned above, cyberthreats can damage the charging system and potentially the battery system. To reduce the risk to the vehicle systems there is provided a second sensor 2A and a second isolation switch 3A. In the event that excessive battery charge voltage or current is provided to the battery system, the battery system can be isolated from the supply of power, even if the voltage provided at input 1 is within its ordinary operating levels. Sensor 2A detects the voltage and current being supplied to the battery system 6 and compares this voltage to the specified charge voltage that would be appropriate as a function of the state of charge of battery 6. According to specifications of the battery system 6 it can be determined by logic system 4 whether an appropriate current and voltage are being provided to switch 3A for charging of the battery 6, or whether there is come charging fault. If sensor 2A detects voltage or current indicating that the input parameters specified for the battery system 6 are being violated, then logic circuit 4 isolates the input from the battery by opening switch 3A to avoid any system damage resulting from this charging fault. Once the battery system is protected from charging fault (conditions that are outside of the specified acceptable charging conditions) and the vehicle is protected from deviant inputs from the source of charging power, there is a substantial improvement in the security of the vehicle regarding potential damage originating from the charge source, whether it be voltage variations or cyberattacks. Another aspect of the invention involves a method and system that facilitates optimization of grid utilization. Peak/off peak logic unit 7 operates to manage the cost of battery charging as a function of the rate schedule provided by or relating to the electric utility provider. This rate schedule is preferably actually applicable to the charge station or charge outlet, but it would be acceptable to rely on a generic rate schedule indicative of typical rates and time schedules if there is not specific information available for the specific location of the charge location being employed for vehicle charging. External communication unit 8 accesses available rate schedule information provided in relation to the power supply being employed, specific or otherwise. This information is provided to the peak/off peak logic unit 7 for use in calculating a cost effective charge schedule for battery system 6. Peak/off peak logic unit 7 stores the best available rate schedule, either a default schedule (when no location applicable schedule has been accessed) or specific applicable information when it has been accessed. Updates can be downloaded when available through any of radio, Wi-Fi, satellite or some form of local or alternate communication. Communication of rate schedules might be available through a wired communication available at the source of the electrical power or other location.

The charging system operates to charge the battery whenever off peak charge rates are available. The vehicle operator can simply plug in the system and the system will manage the time and duration of vehicle charging. If the battery charge requirements allow for deferral of battery charging until the next specified off peak time offered by the electric utility provider, then the peak/off peak logic 4 isolates the grid input from the vehicle until off peak charging rates become available. However, if deferral until off peak rates apply is not feasible then battery charging commences before off peak rates become available. By calculating the total time available for charging the battery and the total time needed for charging the battery deferral of commencement of battery charging is possible through at least a portion of the peak charging rates, commencing charging before the end of peak rates yet allowing sufficient time for complete battery recharge, allowing for complete utilization of the available off peak charging interval. To facilitate assessment of the amount of time needed for battery charging a user input identifying the next anticipated vehicle trip can be entered specifying anticipated departure time and travel details such as distance to be traveled. This might be efficiently managed in conjunction with a vehicle navigation system allowing for indication of proposed departure time and vehicle destination. The navigation system could calculate the trip distance and duration and this information could be used by the battery management system to determine how much battery storage energy is needed for completion of the anticipated trip. Then battery charge duration can be determined as a function of trip parameters and the specifications of the battery system 6. With battery charge duration determined, the current time being known, and the schedule of peak/off peak charge intervals being known, it can be determined how much of the charging can be carried out during periods when off peak charging rates apply and how much of the charging cannot. This allows commencement of battery charging from the grid at a time that optimizes utilization of off peak charging. In a more preferred embodiment of the invention, more than two tiers of energy rates are offered by the electrical utility and the system determines utilization of each tier on a prioritized basis, allowing exhaustion of the lowest price tier before deciding to utilize energy from the next lowest price tier. For each price tier, the system seeks to fully utilize all lower available price tiers first and to then move to the next available lowest remaining price tier. Finally, on the event that pricing is set according to an algorithm, equation, or other non-constant rate, the system optimizes the utilization of the lowest available rates during the available time period and for the full time needed for charging the batteries. Additional management of the use of grid power is made possible try including an integration function for onboard charge systems 9 such as solar photovoltaic and thermoelectric auxiliary power generation system. Instead of employing grid power exclusively, or even as a priority, the battery management system 5 assesses the power generation capabilities of onboard systems 9 and relies on the full capacity of these systems on a prioritized basis instead of primarily employing grid power for battery recharge. It is an advantage of the invention that the onboard power generation systems can continue to charge the battery system even when switch 3 provides an isolation of the grid from the vehicle. This would occur when grid power is not within specifications, but only then when there is also no cyberattack present. When there is evidence of a cyber-attack, this integration function is also protected from cyberattacks through the operation of switch 3A as controlled by the logic system 4. While it is not expected to be the typical cyberattack approach, it is possible that onboard charging systems could be targeted. To protect the batteries from such an attack the logic 4 could isolate both the input and output from battery controller 5 in the event of any deviant charging conditions. This would protect the batteries from both grid power anomalies and from onboard system anomalies.

The battery protection system can also isolate the battery system from both onboard systems and grid power during periods of threat and can isolate just grid power during times of peak energy prices, leaving onboard systems connected during peak energy price periods, provided there is no detected threat. The calculation of grid-based charging times required is a function of the battery state of charge (indicative of the energy retained in the battery system) and the amount of energy required to bring the battery up to the reserve level called for by the battery management system—based on factors including the duration of the next anticipated trip, the amount of time remaining before the next anticipated trip, the optimized rate of charge available from on-board charging systems and the rate of charge available from the available grid charging system. Another factor in assessing or estimating the rate of charge available from onboard systems is derived from predicted weather—such as anticipated number of hours of sunlight during the battery recharge cycle. External communication unit 8 communicates with available sources of weather information to gather information related to weather factors such as the projected sunrise and sunset as welt as the extent to which there will be direct sunlight or partial sunlight over the projected battery recharge cycle timeframe. By considering the expected solar charging contribution to the overall battery charge cycle it is possible to meet battery charging needs while optimizing the reliance on grid charging. Predicted weather unit 11 provides potential power generation capabilities from the solar generation component of the onboard power generation suite 9 to aid in assessing the duration of grid-based charging during the charge cycle. For an overnight charge cycle, when no travel is anticipated the following day, the system can rely on off peak charging to the fullest extent available, even deferring some charging until the following day when solar charging might complete the charge cycle, bringing the battery system to full charge. When a trip is planned for the morning, the charge cycle can be completed overnight, even if a portion of the charging needs to rely on peak hour charge rates. An additional contribution to the recharging cycle is derived from a thermally powered generation component (TEG) of the onboard charging suite 9. This generation contribution will often be available for a period of time after the vehicle is initially stopped, while components of the vehicle are still hot and can provide incremental heat for power generation. This will contribute early charging during the charge cycle and can all for an incremental reduction in the requirements for grid-based charging. Battery controller 5 can integrate the power supplied by the onboard power generation suite with the grid-based power to optimize overall recharge costs.

Even though price optimization will be achieved by following the above described procedure it may be desirable to implement a battery charge precaution sequence that provides a base level recharge promptly upon connection of the vehicle to a power supply. Pursuant to this precaution procedure the driver is protected from changes in planned travel that might require use of the vehicle in advance of the otherwise anticipated next trip. A desirable implementation of the invention provides a system that allows the driver to specify a minimum charge level to be attained before activation of the automated control of the charge prioritization features. To implement this procedure, the battery is charged to a first stage state of charge regardless of the status of the peak/off peak rate schedule and once this first stage state of charge is reached the cost management function of the peak/off peak unit is initiated and further charging of the battery is completed according to the above described cost efficient process and procedure. The first stage state of charge might be user selectable to allow the driver to specify the vehicle range that will always be promptly restored when the vehicle is connected to a charge outlet. This will avoid having a seriously discharged battery in situations where the driver suddenly discovers (or remembers) that another, earlier, trip is necessary.

Another driver-selectable option is a system override feature allowing the driver to disable the cost management function and to proceed with a full battery recharge at the fastest possible rate. In this situation the reliance on onboard power generation can still be used on a priority basis, but grid power is additionally employed to bring the total recharge power up to the maximum level accepted by the battery management system.

1. A battery charging system that isolates the charger input from the battery controller upon detection of a charge voltage that is out of specification, that isolates the input from the battery controller upon detection of a cyberattack, that prioritizes onboard charging capabilities over grid power, that isolates the battery controller from the battery upon detection of a cyber-attack, that normally prioritizes use of off peak grid power over peak grid power and that allows a user to disable the prioritization of the off peak grid power over peak grid power.

2. A system as claimed in claim 1 wherein said system restores the connection of the charger input to the battery controller after confirmation that the charge voltage is returned to within specification.

3. A system as claimed in claim 1 wherein said system reconnects the input to the battery controller after confirmation that said cyber-attack is no longer active.

4. A system as claimed in claim 1 wherein said system allows said user to specify a minimum charge level to be attained before activation of the automated control of the charge prioritization features.

5. A system as claimed in claim 1 wherein onboard power generation capabilities are estimated as a function of predicted weather.

6. A battery charging arrangement for a battery system of an electric vehicle, said battery charging arrangement having an input within said vehicle for receipt of electric charging power from outside said vehicle, a sensor for detecting the voltage received at said input, a switch for selectively connecting said input to or isolating said input from said battery system, and a controller for normally operating said switch to connect said input to said battery system when the voltage received is within a range of voltages suitable for operation of said battery system and for operating said switch to isolate said input from said battery system when the voltage received is outside said range of voltages.

7. An arrangement as claimed in claim 6 wherein said sensor continues to monitor the input voltage when isolation is active and restores the connection after the input voltage returns to within said range of voltages.

8. A battery charging arrangement for a battery system of an electric vehicle, said battery charging arrangement having an input within said vehicle for receipt of electric charging power from outside said vehicle, a sensor for detecting the voltage received at said input, a switch for selectively connecting said input to or isolating said input from said battery system, and a controller for operating said switch to isolate said input from said battery system when the voltage received is indicative of a charging fault.
